(19) United States
(12) Patent Application Publication
(10) Pub. No.: US 2025/0042205 A1
(43) Pub. Date: Feb. 6, 2025

(54) NON-PNEUMATIC TIRE

(71) Applicant: The Goodyear Tire & Rubber Company, Akron, OH (US)

(72) Inventors: Daniel Ray Downing, Uniontown, OH (US); Nathan Edward Yensho, Akron, OH (US)

(21) Appl. No.: 18/362,277

(22) Filed: Jul. 31, 2023

(51) Int. Cl. B60C 15/00; B60C 15/06

(52) U.S. Cl. CPC B60C 15/0009; B60C 15/0628

(57) ABSTRACT

The invention is directed to a non-pneumatic tire comprising a tread band, sidewalls having each a carcass ply, wherein each of the carcass plies extends only on one lateral side of the tire. Radially outer end portions of the carcass plies are attached to the tread band in parallel to the tread band and point essentially in opposite axially outer directions. The invention is also directed to a non-pneumatic tire comprising a tread band and first and second carcass plies, wherein each of these carcass plies is provided on only one lateral side of the tire and has two radially inner bead portions, a radially outer top portion attached to the tread band and two intermediate portions extending transversely to the tread band from the top portion to the respective bead portion. Furthermore, the present invention is directed to tire rim assemblies comprising such tires.

### FIELD OF THE INVENTION

The present invention is directed to non-pneumatic tires and tire rim assemblies comprising such tires.

### BACKGROUND OF THE INVENTION

An advantage of non-pneumatic tires consists in that they do not require pressured air within a tire cavity and are thus puncture resistant. However, a typical disadvantage of non-pneumatic tires consists in that they require complex manufacturing methods and/or different tire components than conventional pneumatic tires. While progress has been made in the field of developing non-pneumatic tires over the past years, significant room for improvement remains.

### SUMMARY OF THE INVENTION

In a first aspect, the present invention is directed to a non-pneumatic tire comprising a circumferential tread band, a first sidewall, and a second sidewall wherein the first sidewall comprises a first carcass ply and the second sidewall comprises a second carcass ply. The first carcass ply extends only on a first lateral side of the tire and the second carcass ply extends only on a second lateral side of the tire, which is opposite to the first lateral side. Each of the first and the second carcass plies has a circumferential and radially outer end portion attached to the tread band, a circumferential and radially inner bead portion, and a circumferential intermediate portion extending, between the outer end portion and the respective inner bead portion, transversely to the radially inner surface of the tread band. The radially outer end portion of the first carcass ply is attached to the tread band in parallel to the tread band and points in a first, essentially axially outer direction, whereas the radially outer end portion of the second carcass ply is attached to the tread band in parallel to the tread band and points in a second, essentially axially outer direction which is opposite to the first axially outer direction.

In a second aspect, the present invention is directed to a tire rim assembly comprising the tire according to the first aspect, optionally according to one or more of its embodiments, and a rim. The rim has a first circumferential flange portion radially supporting and forcing the bead portion of the first carcass ply in a first axial direction, and a second circumferential flange portion radially supporting and forcing the bead portion of the second carcass ply in an axial direction opposite to the first axial direction.

In a third aspect of the present invention, the present invention is directed to a non-pneumatic tire comprising a circumferential tread band, a first carcass ply and a second carcass ply, wherein the first carcass ply is only provided on a first lateral side of the tire and the second carcass ply is only provided on a second lateral side of the tire. Each carcass ply comprises two radially inner bead portions, a radially outer top portion attached to the tread band and two intermediate portions. Each intermediate portion extends transversely to the tread band from the top portion to the respective bead portion.

In a fourth aspect of the present invention, the present invention is directed to a tire rim assembly comprising a rim and the tire in accordance with the third aspect, and optionally according to one or more of its embodiments.

In a fifth aspect of the present invention, the present invention is directed to a tire rim assembly comprising a rim and two non-pneumatic tires, either comprising at least one of the tires according to the first aspect or comprising at least one of the tires according to the third aspect, wherein the two non-pneumatic tires are mounted laterally beside each other on the rim.

### BRIEF DESCRIPTION OF THE DRAWINGS

The invention will be described by way of example and with reference to the accompanying drawings in which:

FIG. 1 is a schematic cross-section showing an embodiment of a non-pneumatic tire in accordance with the present invention;

FIG. 2 is a schematic cross-section showing another embodiment of a non-pneumatic tire in accordance with the present invention, in which two axially inner bead portions extend further in a radially inner direction than axially outer bead portions of the tire;

FIG. 3 is a schematic cross-section showing a tire rim assembly comprising the tire of FIG. 1 mounted to a corresponding rim;

FIG. 4 is a schematic cross-section showing a tire rim assembly comprising the tire of FIG. 2 mounted to a corresponding rim;

FIG. 5 is a schematic cross-section showing yet another non-pneumatic tire in accordance with an embodiment of the present invention according to the third aspect;

FIG. 6 is a schematic cross-section showing a tire rim assembly comprising the tire of FIG. 5 mounted to a corresponding rim;

FIG. 7 is a schematic cross-section showing another non-pneumatic tire in accordance with another embodiment of the present invention;

FIG. 8 is a schematic cross-section showing a tire rim assembly comprising the tire of FIG. 7 mounted to a corresponding rim; and

FIG. 9 is a schematic cross-section showing an embodiment of another tire rim assembly in accordance with the third aspect of the present invention.

### DETAILED DESCRIPTION OF THE INVENTION

In accordance with the first aspect, a non-pneumatic tire comprises a circumferential tread band, a first sidewall, and a second sidewall wherein the first sidewall comprises a first carcass ply and the second sidewall comprises a second carcass ply. The first carcass ply extends only on a first lateral side (or, in other words, in a first lateral half) of the tire and the second carcass ply extends only on a second lateral side (or, in a second lateral half) of the tire, which is opposite to the first lateral side (or half). Each of the first and the second carcass plies has a circumferential and radially outer end portion attached to the tread band, a circumferential and radially inner bead portion, and a circumferential intermediate portion extending, between the radially outer end portion and the respective radially inner bead portion, transversely to the radially inner surface of the tread band. The radially outer end portion of the first carcass ply is attached to the tread band (particularly, to a radially inner side or surface of the tread band) in parallel to the tread band and points in a first, essentially axially outer direction, whereas the radially outer end portion of the second carcass ply is attached to the tread band (particularly, to a radially inner side or surface of the tread band) in parallel to the tread band and points in a second, essentially axially outer direction, which is preferably opposite to the first axially outer direction.

It has been found by the inventors that such an arrangement of the carcass ply which can be considered as split and/or inverted with respect to conventional carcass plies is of advantage for the provision of non-pneumatic tires. The design is robust and closed to debris. It is also easy to tension such carcass plies with a corresponding rim, such as in an inner axial direction.

In one embodiment, each of the first and second carcass plies has a circumferential, curved portion between its end portion being parallel to the tread band and its intermediate portion extending transversely to the radially inner surface of the tread band.

In another embodiment, a circumferential rubber bead (or strip) is attached on at least one lateral side of the curved portion, preferably to reinforce the curved portion between the respective radially outer end portion and the respective intermediate portion. For instance, the rubber strip could be made or consist of a rubber composition, such as an apex rubber composition. In addition, or alternatively, said rubber composition may have a stiffness G′ within a range of 5 MPa to 50 MPa, preferably 10 MPa to 40 MPa, 10 MPA to 30 MPa, 5 MPa to 25 MPa, or 10 MPa to 25 MPa and/or a Shore A hardness within a range of 75 to 99, preferably 80 to 99, 85 to 95, 80 to 90, or 85 to 90. Optionally, a rubber bead or strip may be a circumferential stiffener, comprising or consisting of a rubber composition, e.g., with a stiffness and/or hardness in the above-mentioned ranges. The rubber beads/stiffeners may additionally tension the respective carcass ply, in particular its curved and/or intermediate portion, in an axial direction, such as an axially outer direction.

G′ is determined herein at a temperature of 100° C., a frequency of 1 Hz, and 1% strain, with an RPA 2000™ Rubber Process Analyzer of the company Alpha Technologies, based on ASTM D5289, or equivalent.

Shore A hardness is determined herein at 23° C. according to ASTM D2240 or equivalent.

In still another embodiment, the rubber bead or strip is reinforced by textile cords. However, in a preferred embodiment, the rubber bead or strip is devoid of a cord reinforcement.

In still another embodiment, a first circumferential rubber bead is attached to a laterally outer side of the curved portion to connect at least a part of the radially outer end portion with a radially upper part of the intermediate portion, and/or a second circumferential rubber bead is attached to a laterally inner side of the curved portion to connect the curved portion with the tread band (e.g., with a radially inner side or surface of the tread band) radially above the curved portion.

In still another embodiment, at least one of the radially outer end portions (or each of them) extends axially along the tread band over an axial width within a range of 2% (preferably 5%) to 20% of the total axial width of the tread band.

In still another embodiment, the tread band comprises a circumferentially extending tread and a circumferentially extending shearband arranged in parallel to and radially below the tread, and/or the carcass plies are attached to a radially inner surface of the shearband.

In still another embodiment, the tire is devoid of an innerliner, such as an innerliner comprising butyl rubber.

In still another embodiment, the tire comprises in each bead portion a circumferential bead and/or a circumferential bead apex (which is preferably a rubber component). In addition, or alternatively, the bead comprises one or more metal wires, such as steel wires, wherein the bead apex consists of a rubber composition, preferably devoid of cord reinforcement. It is also an option that the bead is additionally brass coated and/or coated with a rubber composition. The bead and/or the bead apex may be surrounded by the carcass ply, or, in other words, the carcass ply may be folded around the bead and/or the bead apex.

In another embodiment, the bead portion (or each bead portion) is devoid of one or more bead wires and/or an apex. For instance, it is possible to clamp the bead portion of a respective carcass ply between two flanges of the rim at each bead portion.

In another embodiment, each of the radially outer directions points away from the equatorial plane of the tire.

In still another embodiment, each carcass ply comprises a rubber composition reinforced by a plurality of cords. It is possible that such a carcass ply (material) is made as for conventional pneumatic tire, e.g., by a calender (machine). Thus, it is possible to rely at least partially on manufacturing technologies already available for the manufacturing of pneumatic tires.

In still another embodiment, the non-pneumatic tire further comprises a third sidewall and a fourth sidewall, both arranged axially between the first sidewall and the second sidewall, wherein the third sidewall comprises a third carcass ply and the fourth sidewall comprises a fourth carcass ply, wherein the third carcass ply extends only on the first lateral side of the tire and the fourth carcass ply extends only on the second lateral side of the tire. In other words, each of these plies extends only in one lateral half of the tire. Two lateral halves of the tire are divided herein by an equatorial plane of the tire as known in the art. Preferably, each of the third and the fourth carcass plies has one or more of a circumferential and radially outer end portion attached to the tread band (or radially inner side/surface thereof), a circumferential and radially inner bead portion, and a circumferential intermediate portion extending between the outer end portion and the respective inner bead portion transversely to the radially inner surface of the tread band. Optionally, the radially outer end portion of the third carcass ply is attached to the tread band in parallel to the tread band and points in said first, essentially axially outer direction, and/or wherein the radially outer end portion of the fourth carcass ply is attached to the tread band in parallel to the tread band and points in said second, essentially axially outer direction. Such an embodiment may be of particular interest in case of relatively (axially) broad tires and/or tires carrying heavy loads.

In still another embodiment, at least one bead portion of the third and fourth carcass plies extends further into an inner radial direction than the bead portions of the first and the second carcass plies. For instance, such a design may allow easier mounting of the tire to a corresponding rim as described herein further below.

In accordance with the second aspect of the present invention, a tire rim assembly is provided, which comprises a tire in accordance with the first aspect of the invention, or an embodiment mentioned herein, and which further comprises a rim having a first circumferential flange portion radially supporting and/or forcing the bead portion of the first carcass ply in a first axial direction, and a second circumferential flange portion radially supporting and/or forcing the bead portion of the second carcass ply in an axial direction opposite to the first axial direction (when the tire is mounted to the rim).

Such an arrangement of the tire and the rim provides tension to the carcass plies, e.g., in an axially inner (or inward) direction, so as to carry loads in the absence of inflation pressure.

In one embodiment, (at least a part of) one of the bead portions is axially clamped between one of the flange portions and a further flange portion of the rim, which is preferably axially opposite to said one of the flange portions at the clamped bead portion. The clamping helps to avoid tire rim slip.

In another embodiment, an axial distance between axially innermost surfaces of the first bead portion and the second bead portion is at least 30% smaller than a maximum axial width of the tread band, when the tire is mounted to the rim.

In addition, or alternatively, said axial distance is at least 30% smaller than the distance between the axially innermost portions of both radially outer portions of each carcass ply. (still) contacting the tread band, when the tire is mounted to the rim.

In still another embodiment, said axial distance is from 35% to 80% smaller than the maximum axial width of the tread band, when the tire is mounted to the rim; and/or from 35% to 80% smaller than the distance between the axially innermost portions of both radially outer portions of each carcass ply, (still) contacting the tread band, when the tire is mounted to the rim.

In still another embodiment, the rim comprises a first circumferential member comprising the first circumferential flange portion and a second circumferential member comprising the second circumferential flange portion, wherein the first circumferential member is axially mountable to the second circumferential member, preferably to force both bead portions axially towards each other. Thus, preferably, the rim has multiple separate members mountable to one another, such as by fastening means, including, e.g., one or more of bolts, nuts, and screws.

In accordance with the third aspect, a non-pneumatic tire comprises a circumferential tread band, a first carcass ply and a second carcass ply. Each of the first carcass ply and the second carcass ply is provided on only one lateral side of the tire (or in only one lateral half of the tire) and comprises two radially inner bead portions, a radially outer top portion (attached to the tread band) and two intermediate portions. Each intermediate portion extends transversely to the tread band from the top portion to the respective bead portion.

Such an arrangement is of particular advantage in case of relatively broad tires and/or tires carrying heavy loads. Furthermore, such a tire can use the same or similar carcass plies (or carcass ply materials) as already known from conventional pneumatic tires.

In one embodiment, each top portion extends axially along the tread band over 20% to 40% of the maximum axial width of the tread band (measured at the interface of attachment to the tread band).

In another embodiment, both carcass plies are arranged essentially symmetrically to each other with respect to an equatorial plane of the tire.

In the aspects mentioned herein, it is possible that the sidewalls and/or carcass plies are positioned at axial positions depending on one or more of the tire width, targeted load, and application of the tire. This allows usage of equal carcass plies for different tires and/or applications.

In still another embodiment, the axially inner intermediate portion of each carcass ply is radially longer than the axially outer intermediate portion of the same carcass ply. Such an embodiment can simplify mounting of the tire on a rim.

In still another embodiment, each carcass ply has two curved portions, wherein each curved portion is arranged between the top portion of the carcass ply and one of the intermediate portions of the carcass ply, and wherein, optionally, each curved portion is attached to a radially inner surface of the tread band by a circumferential rubber bead or strip. In addition, or alternatively, a rubber bead or strip is provided on one or both lateral sides of one or more of the curved portions. Preferably, such a rubber bead or strip is provided on both lateral sides of all curved portions. The bead or strip may have the same materials and/or properties as mentioned herein in relation to other aspects, and/or may be a stiffener as mentioned herein above.

In another embodiment, the tread band comprises a tread and at least one shearband arranged in parallel to and radially below the tread, wherein each carcass ply is attached to said shearband (on only one lateral side of the tire).

In still another embodiment, the tread band comprises two laterally separate shearbands or shearband portions supporting a (common) tread arranged radially above both shear bands (or shearband portions) and/or extending over radially top surfaces of both shearbands (or shearband portions). Optionally, a circumferential tie strip is arranged radially on top of a slit, and/or bridges such a slit, between the two axially adjacent shearbands (or shearband portions).

In still another embodiment, one or more of the shearbands mentioned herein can be a circumferential band comprising multiple circumferential (e.g., radially stacked) rubber layers. One or more of these rubber layers, may be reinforced by cords.

In still another embodiment, cord reinforcements comprise textile and/or metal cords. Preferably, at least two rubber layers of the band are reinforced by metal cords. In addition, or alternatively, at least two rubber layers are reinforced by textile cords. Thus, it is possible that said shearband or band comprises multiple cord reinforced rubber layers comprising multiple layers which are textile cord reinforced and multiple layers which are metal cord reinforced. Preferably metal cords mentioned herein are made of steel and/or are brass coated.

In still another embodiment, the shearband or band comprises at least four (preferably at least 5 or 6) cord reinforced rubber layers arranged radially on top of each other. The shearband or band preferably comprises less than 20 of such layers.

In still another embodiment, each layer has a radial thickness within a range of 0.2 mm to 3 mm, preferably 0.3 mm to 2.5 mm.

According to the fourth aspect of the present invention, a tire rim assembly comprises a rim and the non-pneumatic tire in accordance with the third aspect, and optionally according to one or more of its embodiments.

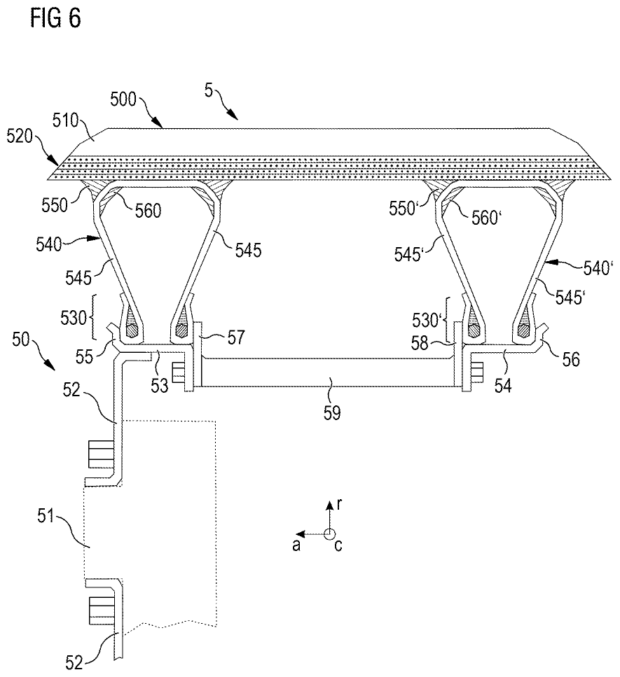

Further exemplary embodiments of such a tire rim assembly are described in relation to FIGS. 6, 8 and 9.

In a fifth aspect of the present invention, the present invention is directed to a tire rim assembly comprising a rim and two non-pneumatic tires, wherein the two non-pneumatic tires are mounted laterally beside each other on the rim. Furthermore, at least one of the non-pneumatic tires is a non-pneumatic tire in accordance with the first aspect, the third aspect, or one or more of their embodiments.

In one embodiment, one or both tires are tires in accordance with the first aspect, or one or more of its embodiments.

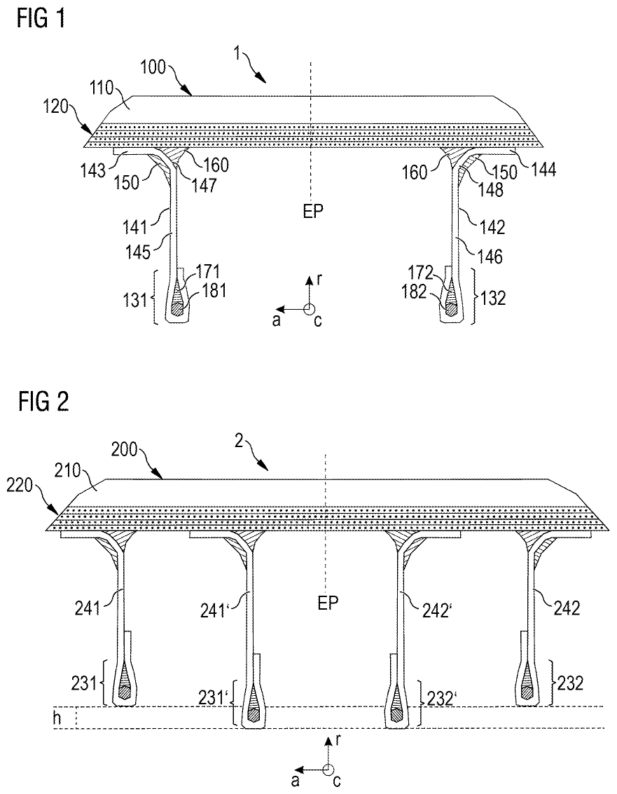

FIG. 1 shows a most preferred embodiment of the present invention. The non-pneumatic tire 1 has a tread band 100 comprising a radially outer tread 110 and a radially inner shearband 120 supporting the tread 110 radially below the tread 110. In this embodiment, the shearband 120 has multiple layers extending in the circumferential and axial directions. Each layer of the shearband 120 is reinforced by cords. Preferably, the shearband 120 comprises at least one layer with metal cords such as brass-coated steel cords and at least one layer having textile cords, such as aramid, polyamide, or polyester/PET cords. However, it is also possible that the shearband 120 has only layers reinforced with metal cords, or only layers reinforced with textile cords. The tire 1 comprises a first sidewall comprising a first carcass ply 141 and a second sidewall comprising a second carcass ply 142 which extend circumferentially in the tire 1. Thus, the carcass plies 141, 142 close the tire 100 at both sides. Each of the first carcass ply 141 and the second carcass ply 142 is only arranged on one lateral side, or in other words, in only one lateral half of the tire 1, wherein the tire 1 is divided into two lateral halves or sides by the equatorial plane EP of the tire 1. In particular, the two carcass plies 141, 142 are not integrally formed with each other and they do not contact each other and/or they are not at least partially arranged on top of each other. However, it would be possible that the tire has on each lateral side multiple carcass plies, such as multiple stacked plies similar to carcass ply 141 on one side of the tire, and/or multiple stacked plies similar to carcass ply 142 on the other side of the tire. In other words, each carcass ply 141, 142 could have multiple carcass ply layers (i.e., in an alternative embodiment not shown in FIG. 1).

Furthermore, the carcass plies 141, 142 comprise radially upper end portions 143, 144. Each of these portions is attached to the tread band 100 and extends in an axially outer direction, or points in an axially outer direction/axially outwards. This may also be described as pointing away from the equatorial plane EP of the tire 1. At radially inner positions, the first and second carcass plies 141, 142 have first and second bead portions 131, 132 comprising beads 181, 182 and bead apexes 171, 172. Between the first and second bead portions 131, 132 the first and second carcass plies 141, 142 have intermediate portions 145, 146. Moreover, the first and second carcass plies 141, 142 have curved portions 147, 148 between their radially upper end portions 143, 144 and the intermediate portions 145, 146. The intermediate portions 145, 146 extend in a direction transverse to the tread band 100.

Furthermore, at said curved portions 147, 148 of the first and the second carcass plies 141, 142 rubber stiffeners 150, 160 are provided which can also be described as rubber beads or strips. In an example, these stiffeners 150, 160 have the same or a similar rubber composition as the first and second apexes 171, 172. These stiffeners help to maintain the curved shape of the carcass plies 141, 142. Moreover, stiffeners 160 arranged on a laterally inner side of the carcass plies 141, 142 further improve the connection between the carcass plies 141, 142 with the radially inner surface of the tread band 100.

In a non-limiting example, the stiffeners (such as stiffeners 150, 160), and/or the apexes (such as apexes 171, 172) can have a rubber composition comprising up to 100 phr of natural rubber and/or synthetic polyisoprene, 65 phr to 90 phr of filler, e.g., selected from one or more of carbon black and silica (preferably, predominantly carbon black), up to 15 phr of oil, and up to 30 phr of resin. In a specific example, the composition has about 100 phr of synthetic polyisoprene, about 75 phr of carbon black, about 10 phr of oil and about 20 phr of resin. A Shore A hardness of such a rubber composition could be within the range of 85 to 95. A stiffness, determined as G′ (1%), may be within a range of 10 MPa to 20 MPa for such a composition.

In another non-limiting example, the carcass plies (such as carcass plies 141, 142) may comprise a rubber composition comprising predominantly natural rubber and/or synthetic polyisoprene, such as from 55 phr to 95 phr of natural rubber and/or synthetic polyisoprene, from 5 phr to 45 phr of a styrene butadiene rubber, from 40 phr to 60 phr of a filler, e.g., selected from one or more of carbon black and silica (preferably, predominantly carbon black), from 5 phr to 30 phr of oil, and up to 10 phr of resin. In a specific embodiment, such a rubber composition comprises about 70 phr of natural rubber, about 30 phr of styrene butadiene rubber, about 55 phr of carbon black, about 20 phr of oil and about 1 phr of resin. A Shore A hardness of such a rubber composition could be within the range of 55 to 65. A respective stiffness (G′ (1%)) may be within a range of 0.5 MPa to 2 MPa for such a composition.

In an embodiment, a rubber composition of the stiffeners and/or the apexes comprises at least 10 weight percent more filler (such as carbon black) than a rubber composition of the carcass plies. In addition, or alternatively, a rubber composition of the stiffeners and/or the apexes comprises from 65 phr to 90 phr of filler, preferably comprising predominantly carbon black; and/or a rubber composition of the carcass plies comprises from 40 phr to 60 phr of filler, preferably comprising predominantly carbon black.

In another embodiment, the rubber composition of the stiffeners and/or the apexes comprises at least 10 weight percent less oil than a rubber composition of the carcass plies. In addition, or alternatively, a rubber composition of the stiffeners and/or the apexes comprises up to 15 phr of oil (e.g., from 0 phr to 15 phr, or from 1 phr to 15 phr of oil, or from 1 phr to 12 phr of oil), and/or the rubber composition of the carcass plies comprises more than 15 phr of oil, such as 17 phr to 30 phr of oil.

The rubber compositions mentioned herein may have a plurality of further ingredients, such as, but not limited to, accelerators, antidegradants, sulfur, zinc oxide, and processing aids.

The axial direction a as indicated herein is parallel to the rotational axis of the tire. The circumferential direction c is perpendicular to that direction and to the radial direction r. Reference to one or more of these directions are not necessarily limited to specific orientations of such a direction, unless indicated otherwise herein in some cases.

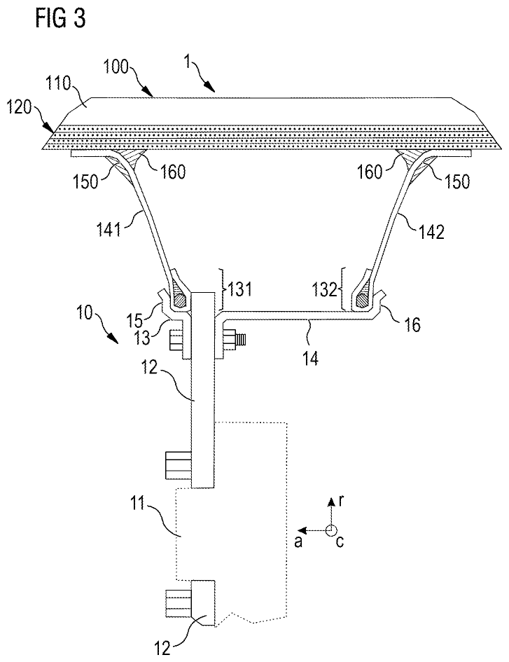

FIG. 3 shows the tire 1 mounted to a rim 10. In other words, tire 1 and rim 10 form a tire rim assembly in which the tire 1 is mounted to the rim 10. The rim 10 has a first circumferential member 13 having a first flange portion 15 and a second circumferential member 14 having a flange portion 16. Each of the members 13, 14 radially supports one of the first and second bead portions 131, 132 of the first and second carcass plies 141, 142. The flange portions 15, 16 tension or force the respective bead 131, 132 in an axially inner direction. Thus, the distance between both bead portions 131, 132 is decreased in the mounted situation shown in FIG. 3 compared to the unmounted situation of the tire 1 shown in FIG. 1. In the present embodiment, each of the circumferential members 13, 14 is mounted to an annular plate 12, e.g., by screw and nut connections as schematically shown in FIG. 3. The plate 12 also extends in an outer radial direction so as to clamp bead portion 131 between a radially upper portion of the plate 12 and the flange portion 15 of the circumferential (or annular) member 13. This arrangement helps to avoid tire rim slip. The annular member 12 is attached to bolts of a hub portion or member 11 arranged centric to the tire axis, and which is preferably a part of a vehicle to which the rim 10 is mounted. The members 12, 13, and 14 are preferably connected or mountable to one another in an axial direction. Moreover, it is possible that some of these members are integrally formed with each other. In addition, or alternatively, the ring member 14 could be integrally formed with member 13. There are various ways to construct an alternative rim and/or rim members. However, preferably such constructions tension the carcass plies 141, 142 at their respective bead portions 131, 132 in an axially inner direction. Preferably, the stiffeners 150, 160 additionally force or tension the carcass plies 141, 142 (in particular their intermediate portion) in an axially opposite, e.g., outer direction.

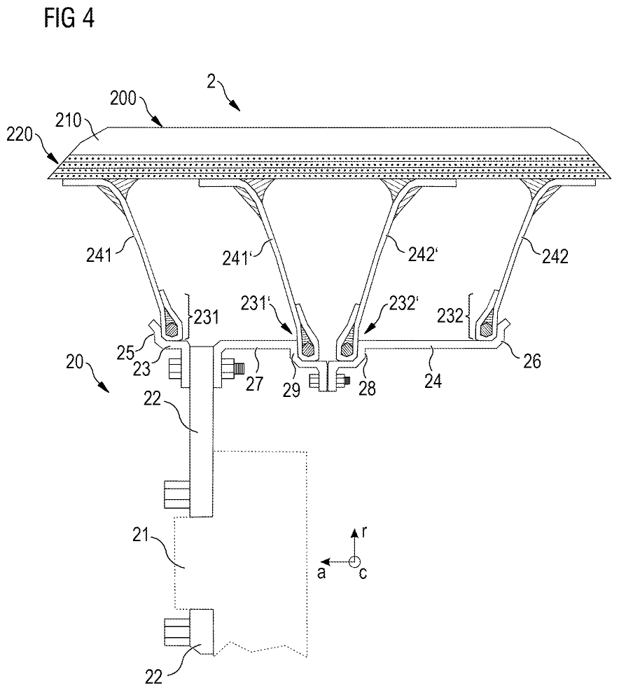

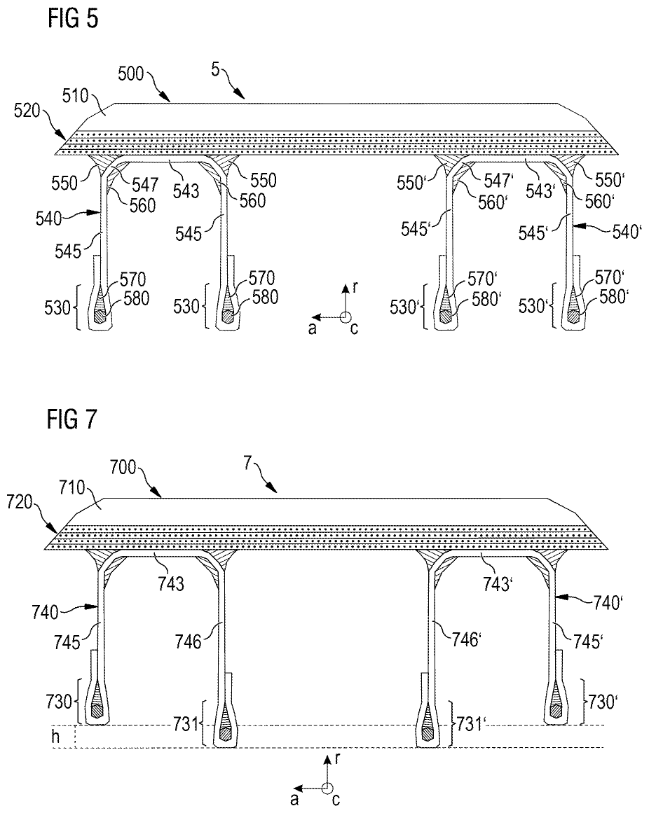

FIG. 2 shows another embodiment of a tire 2, which comprises a tread band 200 comprising a radially outer tread 210 and a radially inner shearband 220. The tire 2 comprises four separate carcass plies 241, 241′, 242, 242′, wherein the carcass plies 241, 241′ have a similar construction as the carcass ply 141 of tire 1, and the carcass plies 242, 242′ have a similar construction as the carcass ply 142 of tire 1. In contrast to the embodiment of FIG. 1, the tire 2 of FIG. 2 has in total four carcass plies instead of two carcass plies, wherein two carcass plies are provided on each side, or in each lateral half of the tire 2, respectively. The radially upper end portion of each carcass ply points in an axially outer direction, away from the equatorial plane EP of the tire 2. In addition, the two axially inner carcass plies 241′ and 242′ extend further radially inwards than the two axially outer carcass plies 241 and 242. Preferably, the two axially inner carcass plies 241′ and 242′ extend to essentially the same radially innermost height. Similarly, the two axially outer carcass plies 241 and 242 preferably extend to essentially the same radially innermost height, which is radially above the radially innermost height of the axially inner carcass plies 241′ and 242′. The difference of the radial heights is indicated with h. Preferably, such a difference is within a range of 5% to 25% of the total radial height of the axially outer carcass plies, measured between a radially innermost position of the respective bead portion 231, 232 and the radially inner surface of the tread band 200. Such a different radial height or extension of the carcass plies is of advantage for mounting the tire to a respective rim as further shown in FIG. 4. The presence of four (separate) carcass plies also helps to carry higher loads, such as in case of axially broad tires or tires which shall carry relatively high loads.

FIG. 4 shows a tire rim assembly comprising the tire 2 shown already in FIG. 2, which is now mounted to the rim 20. Each of the carcass plies 241, 241′, 242′ and 242 is tensioned by the rim 20 in an inner axial direction, i.e., towards the equatorial plane of the tire. In particular, the rim 20 comprises flange portions 25, 29, 28, 26 which force/tension the respective carcass plies 241, 241′, 242′, 242 via their respective bead portions 231, 231′, 232′ 232 in an axially inner direction, i.e., towards the equatorial plane of the tire 2. The rim 20 has multiple circumferential and/or annular members connectable/mountable to one another, preferably as shown here in an axial direction. Connections could be provided with similar means already provided herein in relation to FIG. 3. The rim 20 comprises in the present embodiment an annular member 22 mountable to the hub member 21 (e.g., of a vehicle), wherein the annular member 22 carries (and is connected to) a first circumferential ring member 23 comprising the flange portion 25. Furthermore, the annular member 22 carries (and is connected to) a second ring member 27 having the circumferential flange portion 29. A third ring member 24 is mounted to the second ring member 27 radially below the axially innermost bead portions 231′ and 232′, and comprises circumferential flange portion 28 as well as the circumferential flange portion 26. While a plurality of separate members have been described herein, it is possible that at least some of them are integrally formed with one another. For instance, one or more of members 22, 23 and 27 may be integrally formed with one another. Having multiple members may however allow usage of more equal members for different tires or rim widths. In the present embodiment, none of the bead portions 231, 231′, 232′, 232 is clamped between two flanges axially holding one of said bead portions. However, such an embodiment is also possible herein. For instance, annular member 22 could have a portion axially holding bead portion 231 on a lateral side opposite to the flange portion 25 of the circumferential ring member 23 (not shown).

FIG. 5 shows another embodiment of a tire 5, particularly an embodiment of said third aspect, in which a tire 5 has a tread band 500 comprising a radially outer tread 510 radially supported on a shearband 520, and comprises a first carcass ply 540 as well as a second carcass ply 540′, wherein each of the carcass plies 540, 540′ is provided on only one lateral side of the tire 5 (in other words in only one lateral half of the tire 5). The carcass plies 540, 540′ have radially outer top portions 543, 543′ which are attached to the tread band 500, two radially inner bead portions 530, 530′, and intermediate portions 545, 545′, which extend between the top portions 543, 543′ and the respective bead portions 530, 530′ essentially transversely to the radially inner surface of the tread band 500. The bead portions have beads 580, 580′ and bead apexes 570, 570′ at which the respective carcass ply 540, 540′ is folded around the adjacent bead 580, 580′ and bead apex 570, 570′. Between the respective intermediate portions 545, 545′ and the top portions 543, 543′, the carcass ply 540, 540′ has a curved portion 547, 547′. In particular, the radially outer top portions 543, 543′ of the carcass plies 540, 540′ extend essentially in an axial direction, along the radially inner surface of the tread band 500. The carcass plies 540, 540′ have at their curved portions 547, 547′ circumferential rubber beads/strips, particularly circumferential stiffeners 550, 550′, which connect the curved portions 547, 547′ with the radially inner surface of the tread band 500. Furthermore, the carcass plies 540, 540′ have at their curved portions 547, 547′ further circumferential rubber beads/strips, particularly circumferential stiffeners 560, 560′, which are provided on an opposite side of the respective carcass ply 540, 540′ than stiffeners 550, 550′, or, in other words, on a side of the carcass ply 540, 540′ facing away from the radially inner surface of the tread band 500.

FIG. 6 shows the tire 5 of FIG. 5 mounted on a rim 50. In other words, FIG. 6 shows a tire rim assembly comprising the tire 5 and the rim 50. Accordingly, the same reference signs are used for tire 5 in FIG. 6 as already used in FIG. 5. Each carcass ply 540, 540′ is clamped separately by the rim 50. In particular, the two bead portions 530 are axially clamped/tensioned towards each other by the circumferential flange portions 55 and 57. Similarly, the two bead portions 530′ are axially clamped/tensioned towards each other by the flange portions 56 and 58. In the present embodiment, the rim 50 has an annular member 52 fastened to the hub member 51 of a vehicle (not shown). In principle, it would also be possible that one of the hub members mentioned herein is part of the respective rim, depending on the vehicle hub. A circumferential ring member 53 is welded in this example to the annular member 52 and has the flange portion 55. Moreover, the circumferential ring member 53 supports both bead portions 530 in a radial direction. The second carcass ply 540′ is supported at both bead portions 530′ by the circumferential ring member 54. Both ring members 53, 54 are axially connected by one or more spacing members, preferably by a circumferential spacing member 59. Spacing member 59 comprises integrally formed flanges contacting and tensioning axially inner sides of the axially inner beads into axially outer directions. Various fastening means could be used to connect the different members of the rim used herein as mentioned already with respect to other embodiments recited herein. Flanges or flange portions typically extend in a radially outer direction.

FIG. 7 shows yet another embodiment of a tire 7, comprising a circumferential tread band 700 with a circumferential tread 710 supported by a circumferential shearband 720. Similar to the embodiment of FIG. 5, tire 7 has two carcass plies 740, 740′ wherein each carcass ply is provided in only one lateral half of the tire 7. The carcass plies 740, 740′ have radially outer top portions 743, 743′ which are attached to a radially inner surface of the tread band 700, radially inner bead portions 730, 730′, 731, 731′, and intermediate portions 745, 745′, 746, 746′ which extend between the top portions 743, 743′ and the respective bead portions 730, 730′, 731, 731′ essentially transversely to the radially inner surface of the tread band 700. In the present embodiment, the two axially inner bead portions 731, 731′ extend further in the radially inner direction than the axially outer bead portions 730, 730′. Preferably, their difference in radial extension is h and could be the same or similar as mentioned in relation to other embodiments herein. The top portion 743 is connected with the axially outer bead portion 730 by the intermediate portion 745 and connected with the axially inner bead portion 731 by the intermediate portion 746, all with respect to the equatorial plane of the tire. Similarly, the axially outer bead portion 730′ is connected with the top portion 743′ by the intermediate portion 745′, and the axially inner bead portion 731′ is connected with the top portion 743′ by the intermediate portion 746′. The intermediate portions 745, 745′, 746, 746′ extend transversely to the radially inner surface of the tread band 700.

The bead portions 730, 731, 731′, 730′ have beads and bead apexes, with the respective carcass ply folded around the respective adjacent bead and bead apex. Between an intermediate portion and the top portion each carcass ply has a curved portion. In particular, the radially outer top portions of the carcass plies extend essentially in an axial direction, along the radially inner surface of the tread band 700. The carcass plies 740, 740′ have at their curved portions circumferential rubber beads/strips, particularly circumferential stiffeners, which connect the curved portions with the radially inner surface of the tread band 700. Furthermore, the carcass plies 740, 740′ have at their curved portions further circumferential rubber beads/strips, particularly circumferential stiffeners which are provided on a side of the carcass ply 740, 740′ facing away from the radially inner surface of the tread band 700.

In one embodiment, the minimum axial distance between two carcass plies is at least 30%, preferably at least 40%, of the total axial width of the tread band, such as tread bands 100, 500, or 700.

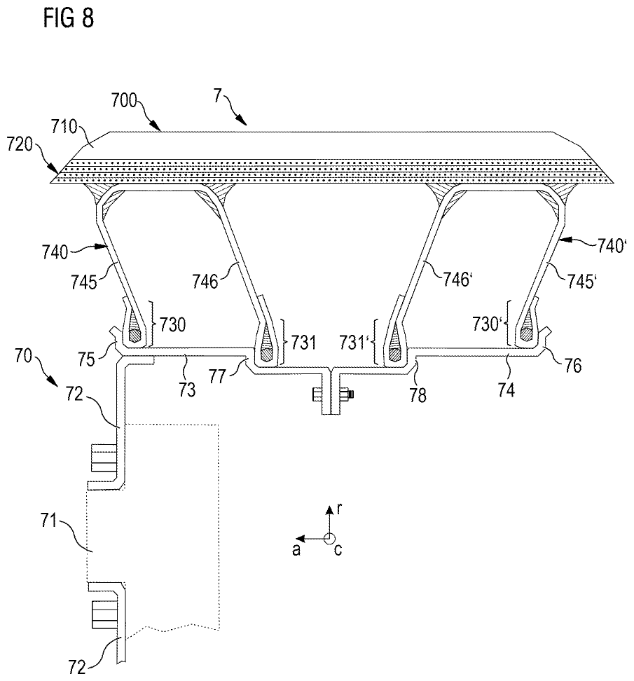

FIG. 8 shows the tire 7 mounted to a corresponding rim 70. The rim 70 comprises multiple members including an annular member 72, a circumferential ring member 73 (here welded to the annular member 72) and a further circumferential ring member 74 axially attached to the circumferential ring member 73. The hub member 71 is preferably part of a vehicle to which the rim 70 is mounted or mountable. In the present embodiment, all bead portions 730, 731, 731′, 730′ are tensioned in an axially inner direction towards the equatorial plane of the tire, particularly by respective circumferential flange portions 75, 77, 78, and 76. Thus, all intermediate portions 745, 746, 746′, 745′ are tilted under tension towards the equatorial plane of the tire. Moreover, the circumferential ring members 73, 74 support all bead portions 730, 731, 731′, 730′, and thus the whole tire 7, particularly in a radially outer direction.

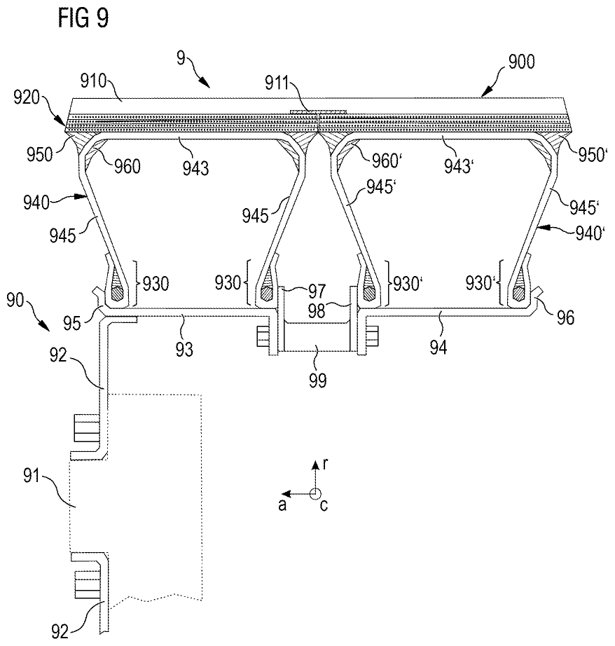

FIG. 9 shows yet another embodiment of a tire rim assembly comprising a tire 9 mounted to a rim 90. The tire 9 as such is similar to tire 5 according to FIG. 5 but the tread band 900 of tire 9 comprises a laterally split shearband 920 which comprise two axially adjacent shearbands, or shearband portions, which are axially connected by the common tread 910. Moreover, a circumferential tie strip 911 (preferably cord-reinforced) is provided radially above an essentially radially extending circumferential slit between the two shearband portions of shearband 920. Thus, the tie strip 911 and the tread 910 bridge the slit between the two axially adjacent portions of the shearband 920. Preferably, the slit is provided essentially along the equatorial plane of the tire 9. The tire 9 has one carcass ply 940, 940′ on each side of its equatorial plane. Both carcass plies 940, 940′ are laterally/axially spaced from each other. Furthermore, the axial distance of both carcass plies 940, 940′ is much smaller than in tire 5 of FIG. 5, i.e., preferably a minimum axial distance between them is within a range of 2% to 20% of the total axial width of the tread 910. The carcass plies have top portions 943, 943′, bead portions 930, 930′, intermediate portions 945, 945′ and curved portions between their respective top portions 943, 943′ and intermediate portions 945, 945′. Moreover, circumferential stiffeners 950, 960, or 950′, 960′ respectively, are provided on both sides/surfaces of the curved portions of the carcass plies 940, 940′.

Still in accordance with the embodiment shown in FIG. 9, two intermediate portions and/or beads of the same carcass ply are axially tensioned towards each other by the rim 90 in a mounted state. In particular, circumferential flange portions 95 and 97 axially tension the intermediate portions 945 via their beads 930 towards each other. Similarly, the circumferential flange portions 98 and 96 axially tension the intermediate portions 945′ via their respective beads 930′ towards each other. In the present embodiment, flange portion 95 is carried by (and integrally formed with) ring member 93 of the rim 90. Flange portions 97 and 98 are carried by (and integrally formed with) the connecting ring member 99 which is axially connected to the ring member 93 and to another ring member 94 which comprises the flange portion 96. Furthermore, ring member 93 is welded to the annular member 92, which is connected or connectable to the hub portion 91, such as of a vehicle.

Rims disclosed herein can also be described as clamping rim assemblies, e.g., comprising multiple rim members.

It is possible that tread bands described herein, e.g., comprising a tread and a shearband, are cured to form a circumferential tread band. In a further step, the circumferential carcass plies could optionally be adhered to the radially inner surface of the tread band. For instance, it is possible to co-cure uncured carcass plies, optionally also stiffeners, to the tread band, e.g., to the cured tread band.

As an option, it is possible to provide the carcass plies held in a segmented drum. Then the tread band could, e.g., be applied circumferentially and co-cured in a curing press.

In case of tires according to the third aspect of the present invention, it is also possible to inflate each carcass ply onto the circumferential tread band, e.g., with a curing tube or bladder. The method could also be the same or similar to tire retreading methods.

In principle, a connection between sidewalls/carcass plies and stiffeners to a tread band can be carried out by various methods known in the tire art. For instance, it is possible to assemble only uncured rubber compositions and/or components and cure them together (for instance, by sulfur cure or peroxide cure).

As another option, it is possible to connect two cured members by adhesives, such as rubber based, silicone based, polyurethane based, or isocyanate based adhesives. Also curing cements such as known from tire retreading may be used. A green rubber layer may also be used to co-cure cured members together.

It is also possible that one of two members to be connected is uncured and the other member is cured. In many cases, it will be possible to co-cure such components. Alternatively, functional groups (such as present in one or more polymers of the components) could be used to bond the members together. Such functional groups may comprise but are not limited to isocyanate, hydroxide, halogenide, amine, amide, carboxylic, epoxide, peroxide, and other suitable groups.

Exact axial widths, axial positions, and/or total radial heights of carcass plies can be adapted by the person skilled in the art based on the actual application without undue experimentation in view of the present disclosure.

In case of embodiments as shown in FIG. 9, it is possible to manufacture each carcass ply connected with one portion of the shearband separately from the second carcass ply connected with the second portion of the shearband. Then, optionally, a tie strip could be applied and/or the common tread could be adhered to the tire, similar as known to the person skilled in the art of tire retreading processes.

Tires and/or tire rim assemblies disclosed herein allow easy tensioning of the tires. In view of the option of inward tensioning, the tires and/or tire rim assemblies are compact. Mounting is relatively easy. Rims can be provided at limited complexity and costs. As the carcass plies extend from the tread bands to the bead portions, noise generation when rolling is reduced, particularly in comparison with non-pneumatic tires having spokes. Moreover, the tires are closed to debris. The design of the tires and/or rims has a relatively low weight. It is also possible to use several elements of the tires and/or rims for different tires sizes and/or rim sizes (e.g., widths).

The embodiments and/or features of the above-mentioned aspects may be combined with one another.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising a circumferential tread band, a first sidewall, and a second sidewall,
wherein the first sidewall comprises a first carcass ply and the second sidewall comprises a second carcass ply, wherein the first carcass ply extends only on a first lateral side of the tire and the second carcass ply extends only on a second lateral side of the tire, opposite to the first lateral side,
wherein each of the first and the second carcass plies has a circumferential and radially outer end portion attached to the tread band, a circumferential and radially inner bead portion, and a circumferential intermediate portion extending between the outer end portion and the respective inner bead portion transversely to the radially inner surface of the tread band,
wherein the radially outer end portion of the first carcass ply is attached to the tread band in parallel to the tread band and points in a first, essentially axially outer direction, and
wherein the radially outer end portion of the second carcass ply is attached to the tread band in parallel to the tread band and points in a second, essentially axially outer direction opposite to the first axially outer direction.

2. The non-pneumatic tire according to claim 1, wherein each of the first and second carcass plies has a circumferential curved portion between its end portion parallel to the tread band and its intermediate portion extending transversely to the radially inner surface of the tread band.

3. The non-pneumatic tire according to claim 2, wherein a circumferential rubber bead is attached on at least one lateral side of the curved portion, to reinforce the curved portion between the respective radially outer end portion and the respective intermediate portion.

4. The non-pneumatic tire according to claim 3, wherein a first circumferential rubber bead is attached to a laterally outer side of the curved portion to connect at least a part of the radially outer end portion with a radially upper part of the intermediate portion, and wherein a second circumferential rubber bead is attached to a laterally inner side of the curved portion to connect the curved portion with the tread band radially above the curved portion.

5. The non-pneumatic tire according to claim 1, wherein at least one of the radially outer end portions extends axially along the tread band over an axial width within a range of 5% to 20% of the total axial width of the tread band.

6. The non-pneumatic tire according to claim 1, wherein the tread band comprises a circumferentially extending tread and a circumferentially extending shearband arranged in parallel to and radially below the tread, and wherein the carcass plies are attached to a radially inner surface of the shearband.

7. The non-pneumatic tire according to claim 1, wherein the tire comprises in each bead portion a circumferential bead and a circumferential bead apex, wherein the bead comprises one or more steel wires, and wherein the bead apex consists of a rubber composition.

8. The non-pneumatic tire according to claim 1, wherein each carcass ply comprises a rubber composition reinforced by a plurality of cords.

9. The tire according to claim 1, further comprising a third sidewall and a fourth sidewall, both arranged axially between the first sidewall and the second sidewall, wherein the third sidewall comprises a third carcass ply and the fourth sidewall comprises a fourth carcass ply, wherein the third carcass ply extends only on the first lateral side of the tire and the fourth carcass ply extends only on the second lateral side of the tire,
wherein each of the third and the fourth carcass plies has a circumferential and radially outer end portion attached to the tread band, a circumferential and radially inner bead portion, and a circumferential intermediate portion extending between the outer end portion and the respective inner bead portion transversely to the radially inner surface of the tread band,
wherein the radially outer end portion of the third carcass ply is attached to the tread band in parallel to the tread band and points in the first, essentially axially outer direction, and wherein the radially outer end portion of the fourth carcass ply is attached to the tread band in parallel to the tread band and points in the second, essentially axially outer direction.

10. The tire according to claim 9, wherein at least one bead portion of the third and fourth carcass plies extends further in an inner radial direction than the bead portions of the first and the second carcass plies.

11. A tire rim assembly comprising the tire according to claim 1 and a rim, wherein the rim has
a first circumferential flange portion radially supporting and forcing the bead portion of the first carcass ply in a first axial direction, and
a second circumferential flange portion radially supporting and forcing the bead portion of the second carcass ply in an axial direction opposite to the first axial direction.

12. The tire rim assembly according to claim 11, wherein at least a part of one of the bead portions is axially clamped between one of the flange portions and a further flange portion of the rim, which is axially opposite to said one of the flange portions at the clamped bead portion.

13. The tire rim assembly according to claim 11, wherein an axial distance between axially innermost surfaces of the first bead portion and the second bead portion is at least 30% smaller than a maximum axial width of the tread band, when the tire is mounted to the rim.

14. The tire rim assembly according to claim 13, wherein said axial distance is from 35% to 70% smaller than the maximum axial width of the tread band, when the tire is mounted to the rim.

15. The tire rim assembly according to claim 11, wherein the rim comprises a first circumferential member comprising the first circumferential flange portion and a second circumferential member comprising the second circumferential flange portion, and wherein the first circumferential member is axially mountable to the second circumferential member to force both bead portions axially towards each other.

16. A non-pneumatic tire comprising a circumferential tread band, a first carcass ply and a second carcass ply, wherein the first carcass ply is only provided on a first lateral side of the tire and the second carcass ply is only provided on a second lateral side of the tire, wherein each carcass ply has two radially inner bead portions, a radially outer top portion attached to the tread band and two intermediate portions, and wherein each intermediate portion extends transversely to the tread band from the respective top portion to the respective bead portion.

17. The tire according to claim 16, wherein each top portion extends axially along the tread band over 20% to 40% of the maximum axial width of the tread band.

18. The tire according to claim 16, wherein the axially inner intermediate portion of each carcass ply is radially longer than the axially outer intermediate portion of the same carcass ply.

19. The tire according to claim 16, wherein each carcass ply has two curved portions, wherein each curved portion is arranged between the top portion of the carcass ply and one of the intermediate portions of the carcass ply, and wherein each curved portion is attached to a radially inner surface of the tread band by a rubber bead.

20. The tire according to claim 16, wherein the tread band comprises a tread and at least one shearband arranged in parallel to and radially below the tread, wherein each carcass ply is attached to the at least one shearband on only one lateral side of the tire.
